(19) United States
(12) Patent Application Publication
(10) Pub. No.: US 2014/0156342 A1
(43) Pub. Date: Jun. 5, 2014

(54) SYSTEM FOR SELECTING TARGET DATA ACCORDING TO ATTENTION TIME AND METHOD THEREOF

(71) Applicants: INVENTEC (PUDONG) TECHNOLOGY CORPOR, Shanghai (CN); INVENTEC CORPORATION, Taipei (TW)

(72) Inventor: Chaucer CHIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/804,563

(22) Filed: Mar. 14, 2013

(30) Foreign Application Priority Data
Nov. 30, 2012 (CN) 201210507825.3

(51) Int. Cl. G06Q 30/02

(52) U.S. Cl. CPC G06Q 30/0201
USPC 705/7.29

(57) ABSTRACT

A system for selecting target data according to attention time and a method thereof are provided. After a user image is captured when target data is displayed, attention time in which a user gazes at the target data is determined according to the captured user image, and statistics are made on the attention time to use the attention time as a technical means for selecting target data in a next time. Responses of the user when the user watches displayed information may be collected, so as to assist a provider of the target data to know whether the user understands the provided target data and/or is interested in the provided target data, thereby achieving the technical efficacy of selecting target data suitable for the user.

### BACKGROUND OF THE INVENTION

1. Field of the Invention

The present invention relates to a system for selecting data and a method thereof, and more particularly to a system for selecting target data according to attention time and a method thereof.

2. Description of Related Art

With the development of technologies, electronic devices can be seen everywhere. Most electronic devices have a display function. Therefore, as programs executed in the electronic devices are different, various different information, such as an interaction message for leisure, a course for learning and health information for prompting, is displayed on the electronic devices. Due to the convenience in carrying, portable electronic devices can be conveniently used by a user in any place and at any time.

However, currently, most electronic devices only have a function of displaying information, but do not have a function of collecting responses when the user sees the displayed information. In this case, a provider of the displayed information always cannot know whether the user can understand the provided information and/or is interested in the provided information, so that the information provider can only determine whether a desired effect is achieved by the provided information indirectly through the number of times of downloading and the number of times of browsing and the like. Therefore, the information provider cannot effectively know a direction for adjusting the content of the provided information.

To sum up, it can be known that in a long period of time, the prior art always has the problem that the information provider cannot effectively know whether the user understands the provided information and/or is interested in the provided information. Therefore, it is necessary to provide an improved technical means to solve the problem.

### SUMMARY OF THE INVENTION

In view of the problem existing in the prior art that the information provider cannot effectively know whether the user understands the provided information and/or is interested in the provided information, the present invention is directed to a system for selecting target data according to attention time and a method thereof.

A system for selecting target data according to attention time of the present invention is applied in a client, and the client may be connected to a server. The system at least includes: a transmission module, used for receiving target data selected by the server; a display module, used for displaying target data; an image capturing module, used for capturing a user image when the display module displays the target data; and an image analysis module, used for determining time in which a user in the user image gazes at the target data as attention time of the target data, so that after the attention time is transmitted to the server by the transmission module, the server can make statistics on statistical data related to the target data according to the attention time, and when transmitting target data to the client the next time, select a new target data to be transmitted from all of the target data according to the statistical data.

Another system for selecting target data according to attention time of the present invention is applied in a server, and the server is connected to at least one client and includes a storage medium. The system at least includes: a data selection module, used for selecting target data to be stored in the storage medium; a transmission module, used for transmitting the target data to the client, and used for receiving a user image transmitted back by the client; an image analysis module, used for determining time in which a user in the user image gazes at the target data as attention time of the target data; and a statistics module, used for making statistics on statistical data related to the target data according to the attention time, so that the data selection module can select the target data according to the statistical data.

A method for selecting target data according to attention time of the present invention at least includes the following steps: a client receiving target data selected by a server, where the client corresponds to a user; the client capturing a user image when the target data is displayed; the client transmitting the user image to the server; the server determining time in which a user in the user image gazes at the target data as attention time of the target data; and the server making statistics on statistical data related to the target data according to the attention time, and when transmitting target data to the client the next time, selecting a new target data to be transmitted from all of the target data according to the statistical data.

Another method for selecting target data according to attention time of the present invention is applied in a client, and the client may be connected to a server. The method at least includes the following steps: receiving target data selected by the server; capturing a user image when the target data is displayed; determining time in which a user in the user image gazes at the target data as attention time of the target data; transmitting the attention time to the server, so that the server can make statistics on statistical data related to the target data according to the attention time, and when transmitting target data to the client the next time, select a new target data to be transmitted from all of the target data according to the statistical data.

The system and the method of the present invention are described as above, and the difference between the present invention and the prior art lies in that in the present invention, after the user image is captured when the target data is displayed, the attention time in which the user gazes at the target data is determined according to the captured user image, and statistics are made on the attention time to use the attention time as a basis for a next target data selection, thereby solving the problem in the prior art, and achieving the technical efficacy of assisting a provider of the target data to select target data suitable for the user.

### BRIEF DESCRIPTION OF THE DRAWINGS

FIG. 1 is an architectural diagram of a system for selecting target data according to attention time of the present invention.

FIG. 2A is a flow chart of a method for selecting target data according to attention time of the present invention.

FIG. 2B is a detailed flow chart of a method of determining attention time of the present invention.

FIG. 2C is a flow chart of an additional method of determining a user expression of the present invention.

FIG. 3 is an architectural diagram of another system for selecting target data according to attention time of the present invention.

FIG. 4 is a flow chart of another method for selecting target data according to attention time of the present invention.

### DESCRIPTION OF THE EMBODIMENTS

Features and implementation manners of the present invention are illustrated in detail below with reference to accompanying drawings and embodiments, so the implementation procedure about how technical means is applied to the present invention to solve the technical problem and achieve the technical efficacy can be fully understood and implemented accordingly.

In the present invention, time in which a user watches displayed target data can be determined through analysis, so as to calculate statistical data related to target data according to the time determined through analysis. The time in which the user watches the displayed target data is referred to as “attention time” in the present invention.

“Target data” of the present invention is data which can convey a specific message such as test questions, curriculum content and health information. The target data may include characters, pictures, videos, symbols and the like, but the target data of the present invention is not limited thereto.

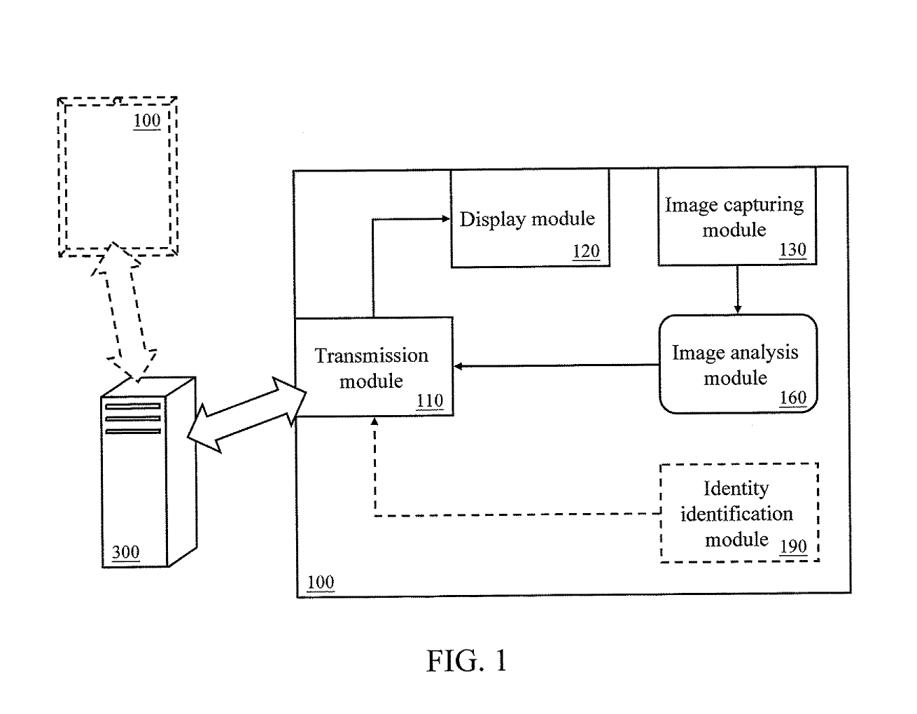

The operation of system of the present invention is illustrated below with reference to FIG. 1 which is an architectural diagram of a system for selecting target data according to attention time of the present invention. As shown in FIG. 1, the system of the present invention is implemented in a client 100, and includes a transmission module 110, a display module 120, an image capturing module 130 and an image analysis module 160.

The transmission module 110 is connected to a server 300 and is responsible for exchanging data with the server 300. The exchanged data includes one or more pieces of target data transmitted by the server 300 to the transmission module 110. The target data transmitted to the transmission module 110 is downloaded and stored in the server 300. The server 300 selects specific target data before transmitting the target data. The server 300 may actively transmit the target data to the transmission module 110, and the transmission module 110 may also actively transmit a data download request to the server 300, so as to download the target data stored in the server 300.

The exchanged data also includes attention time transmitted by the transmission module 110 to the server 300. The attention time transmitted by the transmission module 110 is illustrated together with the image analysis module 160 subsequently.

The display module 120 is responsible for displaying the target data downloaded by the transmission module 110. It should be noted that, the display module 120 is not limited to merely displaying one piece of target data in one display frame one time, and the display module 120 may also display multiple pieces of target data in the same display frame. When the display module 120 displays multiple pieces of target data at the same time, generally the displayed target data does not overlap with each other.

The image capturing module 130 is responsible for capturing an image when the display module 120 displays the target data. The image captured by the image capturing module 130 may completely or partially include a user. The image of the included user is referred to as a “user image” in the present invention. The image capturing module 130 includes, but not limited to, a video camera and a camera.

Generally, the image capturing module 130 captures an image at a fixed time interval, but the present invention is not limited thereto. If the image capturing module 130 does not capture the image at a fixed time interval, the image capturing module 130 generally needs to provide time when the image is captured or a time difference between the time when the image is captured and time when a previous image is captured for the image analysis module 160.

The image analysis module 160 is responsible for determining target data that the user gazes at from the image captured by the image capturing module 130, through analysis. The image capturing module 130 captures the image when the display module 120 displays the target data, but the user may not always stay in front of a device (not shown) that implements the present invention, and also may not keep gazing at a display screen (not shown) of the device that implements the present invention. Therefore, in some embodiments, a part of the image captured by the image capturing module 130 may not include the user, or may not include the eye or the face of the user when including the user, so that the target data that the user gazes at cannot be determined according to the image through analysis.

The image analysis module 160 can determine the position of the eye of the user in the image captured by the image capturing module 130, through analysis, so that the target data that the user gazes at can be determined according to the position of the eye of the user. However a manner in which the image analysis module 160 determines the target data that the user gazes at is not limited to the manner of determining the position of the eye of the user through analysis. Any data that can be determined according to the captured image through analysis can be used as a parameter for the image analysis module 160 to determine the target data. For example, after the angle of the face of the user in the captured image can be determined through analysis, the target data that the user gazes at can be determined by combining the angle of the face of the user and the position of the eye of the user.

When the display module 120 only displays one piece of target data, the image analysis module 160 may first analyze whether the image captured by the image capturing module 130 includes the eye of the user, and if yes, whether a subsequent image of the user image including the eye of the user includes the eye of the user is further determined. When the image analysis module 160 determines that the subsequent image does not include the eye of the user, through analysis, and the image capturing module 130 captures the image at a fixed time interval, the image analysis module 160 may calculate the time in which the user gases at the displayed target data according to the number of the images including the eye of the user. However, if the time when the image capturing module 130 captures the image is not fixed, the image analysis module 160 needs to calculate a time difference between the first image and the last image in the images including the eye of the user, and the calculated time difference is the time in which the user gases at the displayed target data. The time in which the user gazes at the target data that is determined by the image analysis module 160 through analysis is the “attention time” of the present invention.

When the display module 120 displays multiple pieces of target data at the same time, the image analysis module 160 may first analyze whether the image captured by the image capturing module 130 includes the eye of the user, and if yes, the target data that the user gazes at may be further determined according to the position of the eye of the user determined through analysis. In addition, the image analysis module 160 may also analyze whether the subsequent image of the user image including the eye of the user includes the eye of the user, and if yes, the image analysis module 160 may again determine the target data that the user gazes at according to the position of the eye of the user determined through analysis. When the image analysis module 160 determines that the subsequent image does not include the eye of the user, through analysis, or determines that the target data that the user in the subsequent image gazes at changes (that is to say, the position of the eye of the user changes), the time in which the user gazes at the target data may be calculated according to the number of the images in which the user gazes at the same target data, or according to the first image and the last image in which the user gazes at the same target data. The time (that is the attention time) in which the user gazes at target data that is determined through analysis by the image analyzing module 160 corresponds to the target data that is gazed at.

The image analysis module 160 is also responsible for, after determining the attention time corresponding to the target data that is gazed at by the user, transmitting the attention time to the server 300 through the transmission module 110. Generally, when transmitting the attention time, the image analysis module 160 transmits identification data of the target data that the user gazes at to the server 300, so that the server 300 may make statistics on statistical data related to target data according to the attention time of the target data that is transmitted by the transmission module 110, and before the server 300 needs to transmit the target data to the client 100 the next time, the server 300 first selects a new target data to be transmitted from all of the target data according to the statistical data obtained through statistics. The statistical data obtained through statistics by the server 300 includes the target data that the user is likely to pay attention to or to be interested in, a proportion of the target data to which attention is paid, total time that the target data is paid attention to and the like, which is not particularly limited in the present invention, any data of the attention time of target data generated through one or more statistical methods can be taken as the statistical data of the present invention. It should be noted that, in the present invention, the number of the client 100 is not limited to one, and the server may be connected to multiple clients 100, and may perform an overall statistics and analysis according to the attention time transmitted by the clients 100.

In some embodiments, after determining the attention time, the image analysis module 160 does not transmit the determined attention time to the server 300 through the transmission module 110, but further determines whether the attention time reaches a preset time, and if the attention time reaches the preset time, the image analysis module 160 transmits the attention time that reaches the preset time to the server 300 through the transmission module 110.

Further, the image analysis module 160 may determine a user expression corresponding to the target data that the user gazes at according to a face region in the image captured by the image capturing module 130, and transmit the user expression corresponding to the target data that the user gazes at to the server 300 through the transmission module 110, so that the server 300 may determine comparison data corresponding to the target data that the user gazes at according to the user expression transmitted by the transmission module 110, and before the server 300 needs to transmit the target data to the client 100 the next time, the server 300 first selects a new target data to be transmitted from all of the target data according to the statistical data obtained through statistics and the determined comparison data. The comparison data, such as difficulties and the degree of the understanding of the target data, is not particularly limited in the present invention, any data generated when determining the user expression can be taken as the statistical data of the present invention.

In addition, the present invention may further include an identity identification module 190, responsible for identifying an identity (hereinafter referred to as “user identity”) of the user included in the image captured by the image capturing module 130. The identity identification module 190 may determine a user identity according to the face region determined through analysis by the image analysis module 160, and may also identify the user identity according to a fingerprint pressed by the user or an account input by the user, according to identification data stored in an identification card inserted or sensed by the user, or according to hardware identification data in the client that implements the present invention, but the manner in which the identity identification module 190 identifies the user image is not limited thereto.

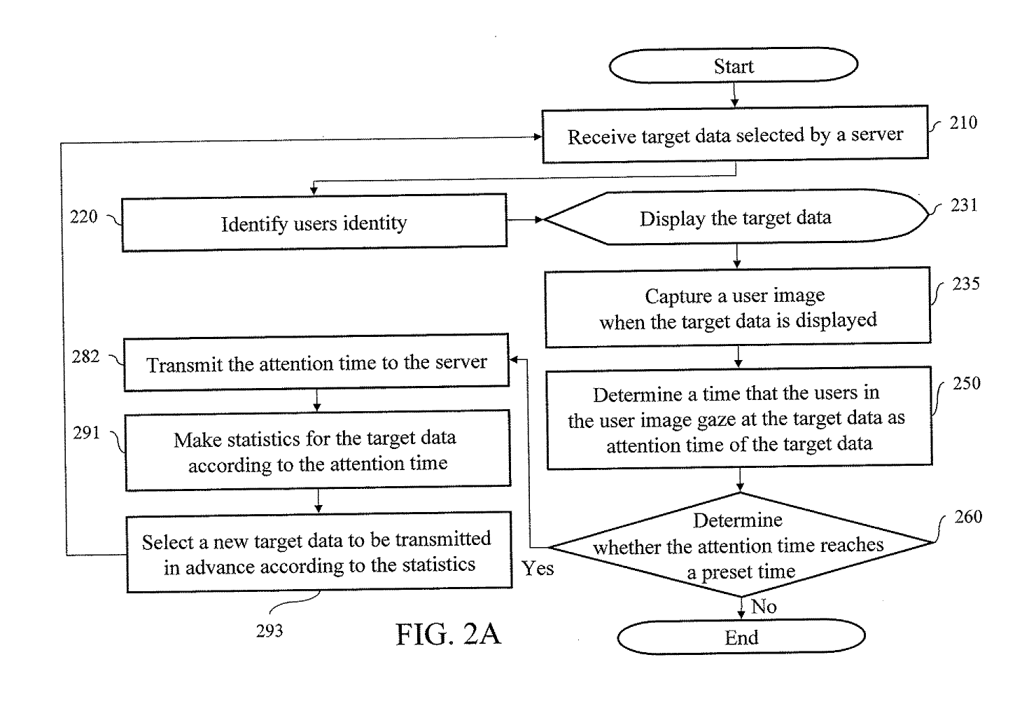

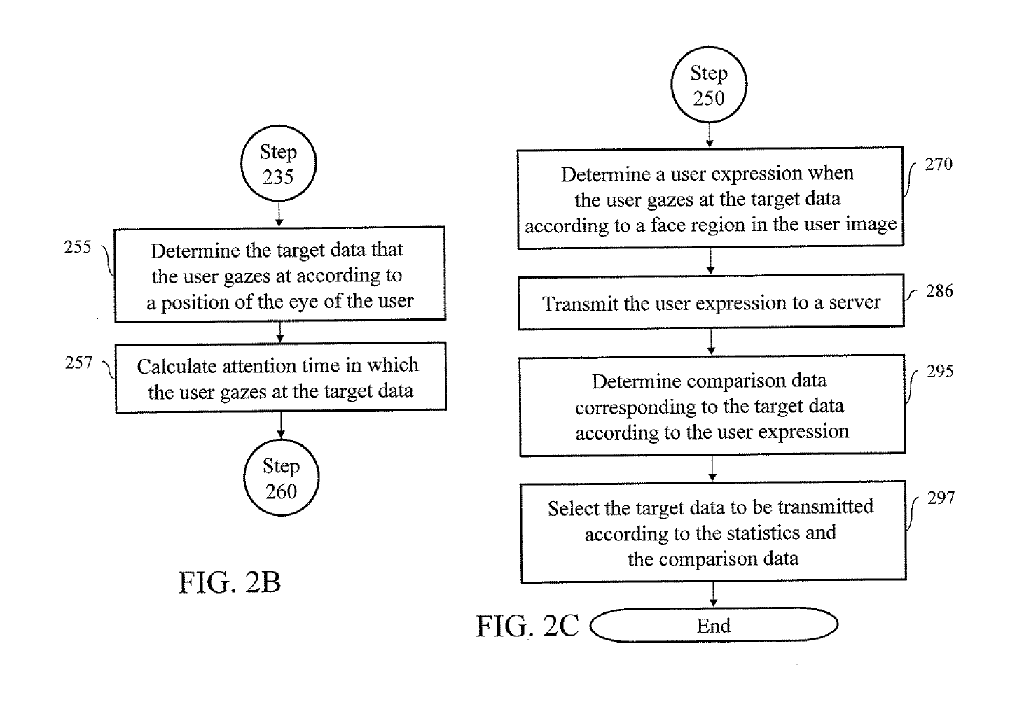

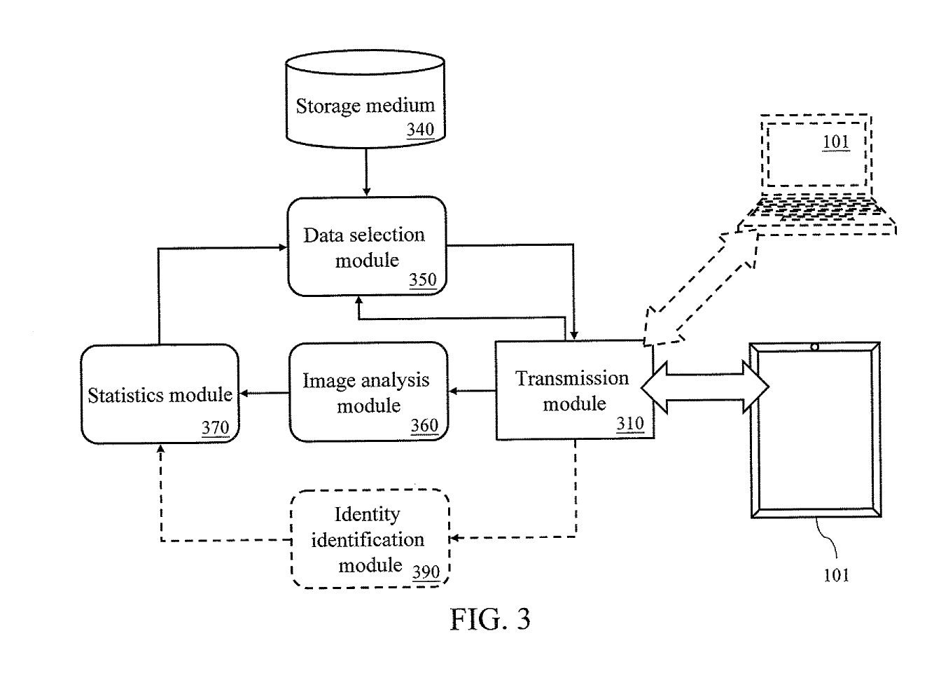

Next, an operation system and method of the present invention are illustrated with reference to a first embodiment. Please refer to FIG. 2A, which is a flow chart of a method for selecting target data according to attention time of the present invention. Assume that, in this embodiment, the present invention is included in instructional software, and the instructional software is executed in a tablet computer including a photographic lens, but the present invention is not limited thereto.

Before the present invention is provided for the user to use, the transmission module 110 first needs to receive the target data transmitted by the server 300. In this embodiment, assume that the target data is a test question, the transmission module 110 first transmits a data download request including a set range to the server 300. After receiving the data download request, the server 300 may select multiple questions from a question bank according to the set range. At this time, if the server 300 does not store any statistical data related to the question bank, the server 300 may randomly select questions, and transmit the selected questions back to the transmission module 110.

After the transmission module 110 receives the target data selected by the server 300 (Step 210), the display module 120 may display the target data downloaded by the transmission module 110 through a display screen of the tablet computer (Step 231), and at the same time, the image capturing module 130 may also start capturing the image (Step 235).

The image analysis module 160 may determine time in which the user in the user image captured by the image capturing module 130 gazes at the target data, and take the determined time as the attention time (Step 250). In this embodiment, assume that the image analysis module 160 determines the test question that the user gazes at according to the position of the eye of the user in the user image (Step 255), and calculates the attention time in which the user gazes at a test question (Step 257), as shown in FIG. 2B.

Returning back to FIG. 2A, after the image analysis module 160 determines the attention time in which the user in the user image gazes at the target data (Step 250), the transmission module 110 may transmit the attention time of the target data determined by the image analysis module 160 to the server 300 (Step 282), so that after receiving a certain amount of attention time, the server 300 may make statistics on statistical data related to the test question according to the attention time (Step 291), and when selecting the target data the next time, select a new target data from all of the target data according to the statistical data obtained through statistics (Step 293). In this embodiment, assume that the server 300 receives the attention time in which different users use the test question, transmitted by the present invention, makes statistics on a proportion of the test question in a sum of all attention time, and evaluates an average speed at which the test question is understood by all users. In this way, when selecting test questions the next time, the number of the test questions corresponding to the test time is selected according to the evaluated average speed, so that a sum of the average speeds at which the selected test questions are understood does not exceed a half of the test time.

In the foregoing embodiment, after the image analysis module 160 determines the attention time in which the user in the user image gazes at the target data (Step 250), the transmission module 110 may not transmit the attention time of the test question (target data) determined by the image analysis module 160 to the server 300 (Step 282), but the image analysis module 160 further determines whether the determined attention time reaches a preset time (Step 260), such as 3 seconds, and if yes, the transmission module 110 transmits the attention time reaching the preset time to the server 300 (Step 282), so as to avoid a situation that the test questions that the user gazes at are not the ones that the user intends to gaze at, which influences the statistical result of the server 300.

In addition, in the first embodiment, after the image analysis module 160 determines the attention time in which the user in the user image gazes at the target data (Step 250), or after the image analysis module 160 determines that the attention time reaches the preset time, the image analysis module 160 may also determine the face region from the user image, and further determine the user expression when the user gazes at the target data according to the determined face region (Step 270), as shown in the flow process in FIG. 2C.

After the image analysis module 160 determines the user expression when the user gazes at the target data (Step 270), the transmission module 110 transmits the user expression determined by the image analysis module 160 when the user gazes at target data to the server 300 (Step 286), so that after receiving a certain amount of user expressions, the server 300 determines comparison data of the target data according to the user expression corresponding to the target data (Step 295), so that when selecting the target data the next time, the server 300 selects a new target data from all of the target data according to the statistical data obtained through statistics and the determined comparison data (Step 297).

In addition, in the first embodiment, if the present invention implemented by a tablet computer further includes an identity identification module 190, the user identity can be identified according to the identification data provided by the user such as a fingerprint, an account and an identification certificate (Step 220) after the transmission module 110 downloads the target data and before the transmission module 110 transmits the attention time determined by the image analysis module 160. When transmitting the attention time to the server 300, the transmission module 110 may also transmit the user identity to the server 300.

The operation of the system of the present invention is illustrated below with reference to FIG. 3, which is an architectural diagram of analyzing an image to determine attention time in which data is gazed at. As shown in FIG. 3, the system of the present invention includes a transmission module 310, a data selection module 350, an image analysis module 360, a statistics module 370 and an optional identity identification module 390.

The transmission module 310 is responsible for transmitting target data selected by the data selection module 350 to a client 101, and receiving an image captured when the client 101 displays the target data. The image received by the transmission module 310 may include a user in whole or in part. In addition, the transmission module 310 may also receive identity identification data transmitted by the client 101. The client 101 may be one, and may also be multiple.

The data selection module 350 is responsible for selecting target data stored in a storage medium 340. The data selection module 350 may select one piece or multiple pieces of target data. Generally, the data selection module 350 may select the target data at least according to statistical data obtained through statistics by the statistics module 370, but when no statistical data is generated by the statistics module 370, the data selection module 350 may select the target data in a random manner or in any other manners.

A function of the image analysis module 360 is the same as that of the image analysis module 160 in FIG. 1, and the difference lies in the source of the analyzed image and the object providing data such as the determined attention time and the user expression. The image analysis module 360 may analyze the image received by the transmission module 310, and analyze the user image received by the transmission module 310, so as to determine the attention time in which the user gazes at the target data, and even to determine the user expression when the user gazes at the target data according to the user image. In addition, after determining the attention time, the image analysis module 360 may further determine whether the attention time reaches a preset time.

The statistics module 370 is responsible for making statistics on statistical data related to the target data according to the attention time of the target data determined by the image analysis module 360, and determine comparison data corresponding to the target data that the user gazes at according to the user expression of the target data determined by the image analysis module 360.

The identity identification module 390 is responsible for identifying an identity of the user included in the image captured by the image capturing module 310 according to the identity identification data received by the transmission module 310.

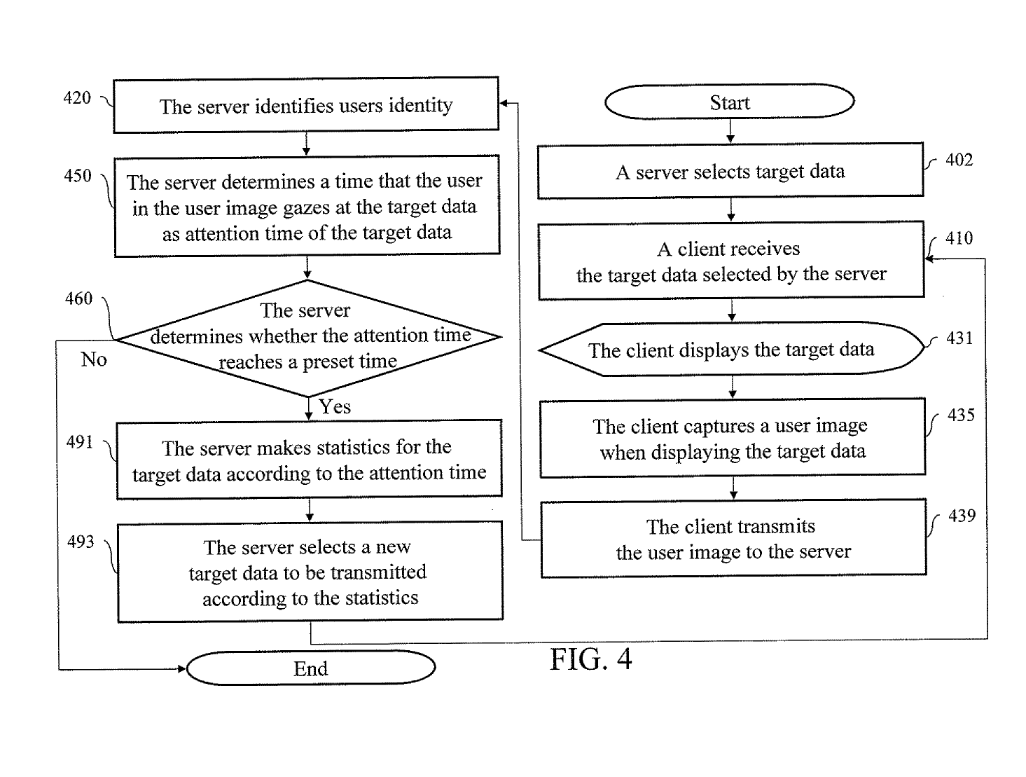

An operation system and method of the present invention are further illustrated with reference to a second embodiment, and please refer to FIG. 4, which is a flow chart of another method for analyzing an image to determine attention time in which data is gazed at. Assume that, in this embodiment, a client 101 is a notebook computer including a photographic camera.

First, the client 101 needs to be connected to a server that implements the present invention. After the client 101 is connected, the data selection module 350 in the server may select target data stored in the storage medium 340 of the server (Step 402), and transmit the target data selected by the data selection module 350 to the client 101 through the transmission module 310. In this embodiment, assume that the target data is a health message, and the data selection module 350 randomly selects one from multiple health advocating messages.

After receiving the target data transmitted by the transmission module 310 of the server (Step 410), the client 101 displays the downloaded target data (Step 431). When the client 101 displays the target data (Step 431), the client 101 may start capturing an image (Step 435), and transmit the captured image to the transmission module 310 of the server (Step 439).

After the transmission module 310 receives the image transmitted by the client 101, the image analysis module 160 may determine time in which the user in the user image received by the transmission module gazes at the target data, and take the determined time as the attention time (Step 450). In this embodiment, the image analysis module 360 may also determine the attention time in which the user gazes at the target data according to the flow process shown in FIG. 2B.

After the image analysis module 360 determines the attention time in which the user in the user image gazes at the target data (Step 450), the statistics module 370 may make statistics on statistical data related to the target data according to the certain amount of attention time determined by the image analysis module 360 (Step 491). In this case, when needing to select target data the next time, the data selection module 350 may select a new target data from all of the target data according to the statistical data obtained through statistics by the statistics module 370 (Step 493). In this embodiment, assume that the statistics module 370 makes statistics on the average time in which all users gaze at the target data, and the data selection module 350 may select the target data of which an average gazing time is the longest.

In the foregoing embodiment, after the image analysis module 360 determines the attention time in which the user in the user image gazes at the target data (Step 450), the image analysis module 360 may further determine whether the determined attention time reaches a preset time (Step 460), and if yes, the image analysis module 360 provides the attention time reaching the preset time for the statistics module 370, so as to avoid influences on the statistic result of the statistics module 370.

In addition, in the second embodiment, after the image analysis module 360 determines the attention time in which the user in the user image gazes at the target data (Step 450), or after the image analysis module 160 determines that the attention time reaches the preset time, the image analysis module 360 may also determine the face region according to the user image, and further determine the user expression when the user gazes at the target data according to the determined region of the user, and provide the determined user expression when the user gazes at the target data for the statistics module 370, so that the statistics module 370 can determine comparison data of the target data according to the user expression when the user gazes at the target data, and when the data selection module 350 needs to select the target module the next time, the data selection module 350 may select a new target data from all of the target data according to the statistical data obtained through statistics by the statistics module 370 and the comparison data determined by the statistics module 370.

In addition, in the second embodiment, if the system further includes an identity identification module 390, after the transmission module 310 receives the image transmitted by the client 101, and before the statistics module 370 makes statistics on the statistical data related to the target data according to the attention time, the identity identification module 390 may further identify a user identity according to identification data provided by the user (Step 420).

To sum up, it can be known that, the difference between the present invention and the prior art lies in that: after a user image is captured when target data is displayed, attention time in which the user gazes at the target data is determined according to the captured user image, and statistics are made on the attention time to use the attention time as a technical means for selecting target data in a next time. By adopting this technical means, the problem in the prior art that the information provider cannot effectively know whether the user understands the provided information and/or is interested in the provided information, so as to achieve the technical efficacy of assisting the target data provider to select the target data suitable for the user.

Furthermore, the method for selecting target data according to attention time of the present invention may be implemented in hardware, software or a combination of hardware and software, and may also be implemented in a computer system in a centralized manner or in a scattering manner in which different components are distributed in several interconnected computer systems.

What is claimed is:

1. A method for selecting target data according to attention time, at least comprising:
receiving at least one piece of target data selected by a server by at least one client, wherein each client corresponds to a user;
capturing multiple user images by each client when the target data is displayed;
transmitting the user images to the server by each client;
determining a time by the server that the users in the user images gaze at the target data as attention time of the target data; and
making statistics for each of the target data by the server according to the attention time, and when transmitting another target data to the client the next time, selecting a new target data to be transmitted in advance according to the statistics.

2. The method for selecting target data according to attention time according to claim 1, wherein the step of transmitting the attention time to the server by each client further comprises: determining that the attention time reaches a preset time and then transmitting the attention time.

3. The method for selecting target data according to attention time according to claim 1, wherein before the client displaying the target data, the method further comprises: identifying the users identities.

4. The method for selecting target data according to attention time according to claim 1, wherein the server is further used for determining a user expression when the user gazes at the target data according to a face region in the user images, and determining comparison data corresponding to the target data according to the user expression, and selecting target data to be transmitted according to the statistics and the comparison data when receiving the data download request again.

5. A system for selecting target data according to attention time, applied in a client, wherein the client is connected to a server, and the system at least comprises:
a transmission module, used for receiving at least one piece of target data selected by the server;
a display module, used for displaying the target data;
an image capturing module, used for capturing multiple user images when the display module displays the target data; and
an image analysis module, used for determining time that the users in the user images gaze at the target data as attention time of the target data, so that after the attention time is transmitted to the server by the transmission module, the server makes statistics for each of the target data according to the attention time, and when transmitting another target data to the client the next time, selecting a new target data to be transmitted according to the statistical data.

6. The system for selecting target data according to attention time according to claim 5, wherein the image analysis module is further used for determining that the attention time reaches a preset time and then transmitting the attention time to the server through the transmission module

7. The system for selecting target data according to attention time according to claim 5, further comprising an identity identification module, used for identifying the users identities.

8. The system for selecting target data according to attention time according to claim 5, wherein the image analysis module is further used for determining a user expression when a user in the user images gazes at the target data according to a face region, and the transmission module is further used for transmitting the user expression to the server, so that the server determines comparison data corresponding to the target data according to the user expression, and when receiving a data download request, selecting target data to be transmitted according to the statistics and the comparison data.

9. A system for selecting target data according to attention time, applied in a server, wherein the server is connected to at least one client, the server comprises a storage medium, and the system at least comprises:
a data selection module, used for selecting at least one piece of target data stored in the storage medium;
a transmission module, used for transmitting the target data to the client, and used for receiving multiple user images transmitted back by the client;
an image analysis module, used for determining a time that the users in the user images gazes at the target data as attention time of the target data; and
a statistics module, used for making statistics for each of the target data according to the attention time, so that the data selection module selects a new target data according to the statistics.

10. The system for selecting target data according to attention time according to claim 9, wherein the image analysis module is further used for determining a user expression when a user in the user images gazes at the target data according to a face region, and the statistics module is further used for determining comparison data corresponding to the target data according to the user expression, and selecting target data to be transmitted according to the statistics and the comparison data when the transmission module receives the data download request again.
